(19) United States
(12) Patent Application Publication
(10) Pub. No.: US 2006/0023875 A1
(43) Pub. Date: Feb. 2, 2006

(54) Enhanced stream cipher combining function

(76) Inventor: Gary L. Graunke, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/909,004

(22) Filed: Jul. 30, 2004

(51) Int. Cl. H04L 9/28

(52) U.S. Cl. 380/28

(57) ABSTRACT

A cryptographic system and method includes generating a plurality of round keys from blocks of a key stream; and performing a combining function. When encrypting a set of blocks of plaintext data into a set of blocks of ciphertext data, each block of plaintext data within the set is processed using a unique combination of a selected key stream block and a selected round key, and the size of the key stream is less than the size of the plaintext data. When decrypting a set of blocks of ciphertext data into a set of blocks of plaintext data, each block of ciphertext data within the set is processed using a unique combination of a selected key stream block and a selected round key, and the size of the key stream is less than the size of the ciphertext data.

### BACKGROUND

1. Field

The present invention relates generally to cryptography and, more specifically, to stream ciphers and combining functions.

2. Description

In some instances, a cryptographic system is used to protect uncompressed video data. Since the video data is uncompressed, the amount of data to be processed for display to a user is very large. Conventionally, encryption of this data using a known block cipher, such as an Advanced Encryption Standard (AES) cipher, for example, is too slow for some content protection applications.

In a typical stream cipher encryption operation, a key stream is applied directly to plaintext data by using a simple combining operation, such as exclusive-or, to produce ciphertext data. Conversely, during a decryption operation, the inverse combining operation is used with the same key stream to change ciphertext data back into plaintext data. One disadvantage to this approach is that it requires the same amount of key stream bits as data to be processed.

What is desirable is a cryptographic system that uses a key stream smaller than the size of the plaintext data in such as way as to improve the performance characteristics of the cryptographic system, yet still provide adequate security.

### BRIEF DESCRIPTION OF THE DRAWINGS

The features and advantages of the present invention will become apparent from the following detailed description of the present invention in which:

FIG. 1 is a high level block diagram of a cryptographic system according to an embodiment of the present invention;

FIG. 2 is a block diagram illustrating key generation processing of a cryptographic system according to an embodiment of the present invention;

FIG. 3 is a block diagram illustrating combining function processing for encryption by a cryptographic system according to an embodiment of the present invention; and

FIG. 4 is a block diagram illustrating combining function processing for decryption by a cryptographic system according to an embodiment of the present invention

### DETAILED DESCRIPTION

An embodiment of the present invention is a method and apparatus for improving stream cipher performance by using portions of a key stream as round keys in a one-round, one-time block cipher. This allows more data to be encrypted or decrypted in the same amount of time while preserving desirable security properties.

In embodiments of the present invention, a small number of blocks of key stream may be computed as is typically done for a base stream cipher, but the blocks of the key stream may now be used as round keys in a short block cipher, with each combination of key stream blocks being used at most once as the basis for the round keys. In one embodiment, a non-linear transformation such as a substitution box (S-Box), may be used between combining operations to deter an adversary from solving for the key stream if some of the plaintext data blocks are known (thus possibly deriving nearby unknown blocks of plaintext). A short block cipher may use corresponding bits from each of multiple blocks as input data to the substitution operation, and multiple blocks may be encrypted or decrypted together. In one embodiment, shifting or other transformations may be done to key stream bits to form subsequent round keys from the initial blocks of the key stream.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

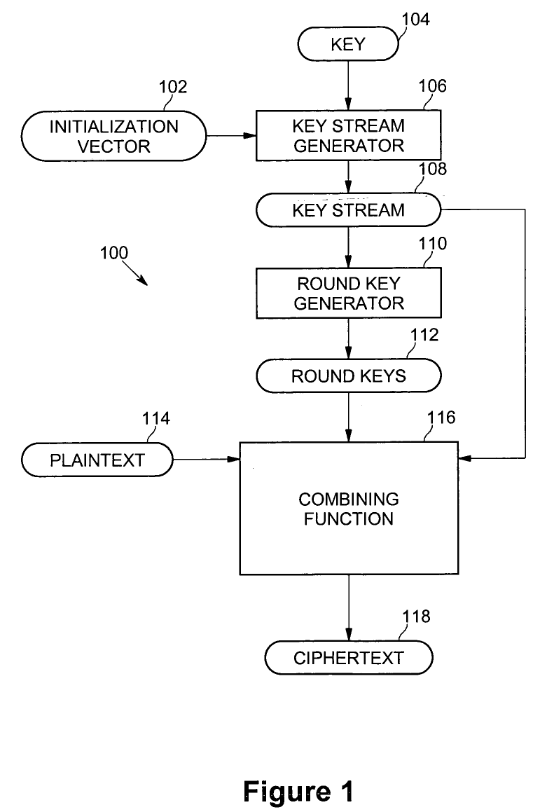

FIG. 1 is a high level block diagram of a cryptographic system 100 according to an embodiment of the present invention. In this system, an initialization vector (IV) 102 and a key 104 may be input to a key stream generator 106. The initialization vector comprises a plurality of randomly or pseudo-randomly generated bits. In one embodiment, the IV may comprise four blocks, wherein the number of bits in each block of the IV may be 128, although in other embodiments other sizes and numbers of blocks may be used. The key 104 may be any sequence of bits. In one embodiment, the key is kept secret. In an embodiment, the number of bits in the key may be 128; in other embodiments other sizes may be used. The key stream generator 106 accepts the key and the IV and generates key stream 108. In one embodiment, the key stream generator generates the key stream based on the input data by employing a known block cipher operating in either counter mode (CTR) or output feedback mode (OFB) according to methods well known to those skilled in the art. In one embodiment, the key stream generator uses an AES cipher. In other embodiments, other known block ciphers may be used. In still further embodiments, a stream cipher (e.g., RC4) could be used as a key stream generator instead of a block cipher. Generally, the key stream may be any arbitrary length of bits. In embodiments of the present invention, the key stream comprises a number of bits less than the number of bits in the plaintext 114 so overall performance of the combining function 116 is improved.

In an embodiment, the key stream 108 may be input to both the round key generator 110 and the combining function 116. The round key generator uses blocks of the key stream to generate a plurality of round keys. In one embodiment, the round keys may be generated in groups of four, by operating on four blocks of the key stream at a time (wherein each block comprises 128 bits in one embodiment). In an embodiment, the round key generator may comprise a logical function such as a shift function (either left or right for a specified number of bits). In other embodiments, other logical functions may be performed on the key stream blocks to generate the round keys. Round keys 112 may be of any arbitrary size. In one embodiment, each round key may comprise 128 bits.

In one embodiment as shown in FIG. 1, the combining function 116 may use the round keys 112 and the key stream 108 to encrypt plaintext 114 into ciphertext 118. Alternatively, a combining function with the inverse mathematical properties may be used to perform decryption of the ciphertext 118 back into plaintext 114 using the round keys and the key stream. Because the key stream is smaller than the plaintext in embodiments of the present invention, the cipher of the present invention generates the ciphertext faster than prior art methods.

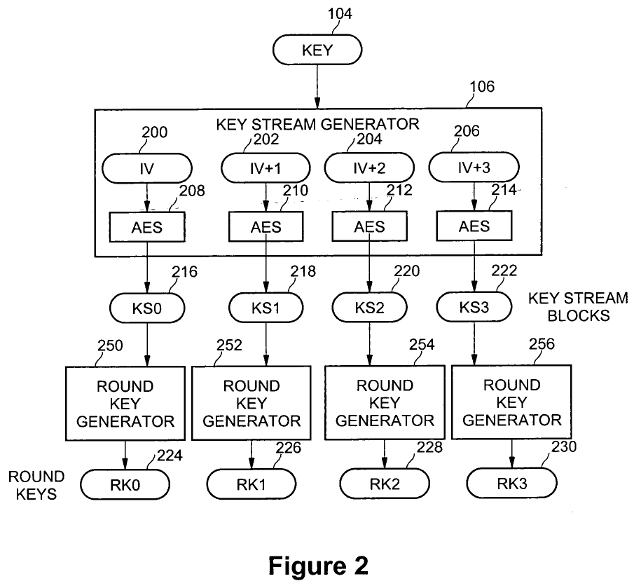

FIG. 2 is a block diagram illustrating key generation processing of a cryptographic system according to an embodiment of the present invention. This diagram illustrates additional details of blocks 106-112 of the embodiment shown in FIG. 1. The key 104 and the IV 102 may be input to the key stream generator 106. The IV may be grouped into four blocks, labeled IV 200, IV+1 202, IV+2 204, and IV+3 206. In one embodiment, each IV block comprises 128 bits. In other embodiments, other sizes may be used. Each block of IV may be input to a block cipher. In one embodiment, the block cipher may be AES. For example, as shown in FIG. 2, the first block IV 200 may be input to a first AES 208, the second block IV+1 202 may be input to a second AES 210, the third block IV+3 204 may be input to a third AES 212, and the fourth block IV+3 206 may be input to a fourth AES 214. Each of the AES ciphers may be used in counter (CTR) mode, for example, to produce a block of key stream based on the selected IV block and the key. When operating on a group of four blocks (in one embodiment), the AES ciphers produces a block of key stream 0 (KS0) 216, key stream 1 (KS1) 218, key stream 2 (KS2) 220, and key stream 3 (KS3) 222, respectively. The key stream generator may be operated to produce successive sets of four key stream blocks over time. The key stream blocks may be input to a plurality of round key generators (RKGs) 250, 252, 254, 256, as shown. Each RKG uses a block of the key stream received as input and generates a round key. When operating on a group of four blocks in one iteration (in one embodiment), the set of four RKGs 250, 252, 254, 256, generate round keys RK0 224, RK1 226, RK2 228, and RK3 230, respectively. In one embodiment, each round key may be 128 bits, although other sizes may be used. Each path of generating the key stream blocks and the round keys may be performed in parallel. In an embodiment, the four RKGs may be combined into a single entity to perform the round key generation function for all four blocks at a time.

The result of the processing of one iteration by the key stream generator and the round key generator is a set of four key stream blocks (KS0, KS1, KS2, and KS3) and four round keys (RK0, RK1, RK2, and RK3), derived from the original key 104 and initialization vector blocks 200, 202, 204, 206. In embodiments of the present invention, each unique combination of a pair of key stream block and round key (e.g., (KS0, RK0), (KS0, RK1), . . . (KS3, RK2), (KS3, RK3)), may be used as keys in two rounds of the combining function 116 to produce 16 blocks of ciphertext from 16 blocks of plaintext. Thus, an encryption or decryption operation may be performed over 16 blocks of data in embodiments of the invention using only 4 blocks of key stream data. This results in a processing improvement of up to a factor of four over prior art systems.

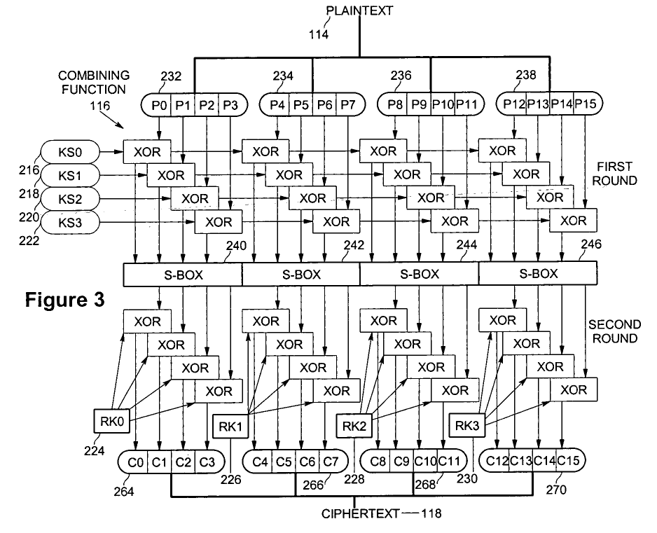

This performance improvement may be obtained as follows. FIG. 3 is a block diagram illustrating combining function processing for encryption according to an embodiment of the present invention. Generally, the combining function comprises two rounds and a set of S-box transformations. Plaintext 114 may be input to the combining function 116. The plaintext is input to a first round of invertible algebraic functions along with selected key stream blocks to produce a first intermediate result. The first intermediate result is sent to a set of four S-boxes. The S-boxes produce a second intermediate result. The second intermediate result is input to a second round of invertible algebraic functions along with selected round keys. The output of the second round comprises ciphertext 118. Each of the blocks in a set of plaintext data may be processed by the combining function to produce a set of blocks of ciphertext data substantially in parallel with all other blocks.

In one embodiment, each successive portion of 16 blocks of the plaintext data stream (at each iteration of the combining function) may be split into four groups of four blocks each: P0, P1, P2, and P3 232; P4, P5, P6, and P7 234; P8, P9, P10, and P11 236; and P12, P13, P14, and P15 238; with each block comprising 128 bits. Thus, in one embodiment, the number of blocks in a set is 16. For first round processing, plaintext block P0 may be input to an invertible algebraic function such as XOR along with key stream 0 (KS0) 216. The output of the XOR handling P0 may be forwarded to a first S-box 240. Plaintext block P1 may be input to an invertible algebraic function such as XOR along with key stream 1 (KS1) 218. The output of the XOR handling P1 may be forwarded to first S-box 240. Plaintext block P2 may be input to an invertible algebraic function such as XOR along with key stream 2 (KS2) 220. The output of the XOR handling P2 may be forwarded to first S-box 240. Plaintext block P3 may be input to an invertible algebraic function such as XOR along with key stream 3 (KS3) 222. The output of the XOR handling P3 may be forwarded to first S-box 240.

In a similar manner, plaintext block P4 may be input to an invertible algebraic function such as XOR along with key stream 0 (KS0) 216. For purposes of clarity of FIG. 3, KS0 is shown as passing through to each of the XOR functions in the row for KS0. The output of the XOR handling P4 may be forwarded to a second S-box 242. Plaintext block P5 may be input to an invertible algebraic function such as XOR along with key stream 1 (KS1) 218. For purposes of clarity of FIG. 3, KS1 is shown as passing through to each of the XOR functions in the row for KS1. The output of the XOR handling P5 may be forwarded to second S-box 242. Plaintext block P6 may be input to an invertible algebraic function such as XOR along with key stream 2 (KS2) 220. For purposes of clarity of FIG. 3, KS3 is shown as passing through to each of the XOR functions in the row for KS3. The output of the XOR handling P6 may be forwarded to second S-box 242. Plaintext block P7 may be input to an invertible algebraic function such as XOR along with key stream 3 (KS3) 222. For purposes of clarity of FIG. 3, KS3 is shown as passing through to each of the XOR functions in the row for KS3. The output of the XOR handling P7 may be forwarded to second S-box 242.

In a similar manner, plaintext block P8 may be input to an invertible algebraic function such as XOR along with key stream 0 (KS0) 216. The output of the XOR handling P8 may be forwarded to a third S-box 244. Plaintext block P9 may be input to an invertible algebraic function such as XOR along with key stream 1 (KS1) 218. The output of the XOR handling P9 may be forwarded to third S-box 244. Plaintext block P10 may be input to an invertible algebraic function such as XOR along with key stream 2 (KS2) 220. The output of the XOR handling P10 may be forwarded to third S-box 244. Plaintext block P11 may be input to an invertible algebraic function such as XOR along with key stream 3 (KS3) 222. The output of the XOR handling P11 may be forwarded to third S-box 244.

In a similar manner, plaintext block P12 may be input to an invertible algebraic function such as XOR along with key stream 0 (KS0) 216. The output of the XOR handling P12 may be forwarded to a fourth S-box 246. Plaintext block P13 may be input to an invertible algebraic function such as XOR along with key stream 1 (KS1) 218. The output of the XOR handling P13 may be forwarded to fourth S-box 246. Plaintext block P14 may be input to an invertible algebraic function such as XOR along with key stream 2 (KS2) 220. The output of the XOR handling P14 may be forwarded to fourth S-box 246. Plaintext block P15 may be input to an invertible algebraic function such as XOR along with key stream 3 (KS3) 222. The output of the XOR handling P15 may be forwarded to fourth S-box 246.

Thus, each of the 16 XOR functions processes one of the 16 plaintext blocks and forwards a block of transformed plaintext data to a substitution box (S-box), respectively. Each S-box 240, 242, 244, 246 comprises a non-linear mapping function to transform a set of four input blocks taken together (e.g., 512 bits from four blocks) into a set of four output blocks. Any S-box known in the art may be employed herein.

The output of each S-box is input to the second round of the combining function, comprising a set of 16 invertible algebraic functions, such as XOR functions. The first ciphertext block 264 may be generated as follows. Ciphertext block C0 may be generated by performing an invertible algebraic function such as XOR on a first block output from the first S-box 240 and a first round key 0 (RK0) 224. Ciphertext block C1 may be generated by performing an invertible algebraic function such as XOR on a second block output from the first S-box 240 and RK0 224. Ciphertext block C2 may be generated by performing an invertible algebraic function such as XOR on a third block output from the first S-box 240 and RK0 224. Ciphertext block C3 may be generated by performing an invertible algebraic function such as XOR on a fourth block output from the first S-box 240 and RK0 224.

In a similar manner, the second ciphertext block 266 may be generated as follows. Ciphertext block C4 may be generated by performing an invertible algebraic function such as XOR on a first block output from the second S-box 242 and a second round key 1 (RK1) 226. Ciphertext block C5 may be generated by performing an invertible algebraic function such as XOR on a second block output from the second S-box 242 and RK1 226. Ciphertext block C6 may be generated by performing an invertible algebraic function such as XOR on a third block output from the second S-box 242 and RK1 226. Ciphertext block C7 may be generated by performing an invertible algebraic function such as XOR on a fourth block output from the second S-box 242 and RK1 226.

In a similar manner, the third ciphertext block 268 may be generated as follows. Ciphertext block C8 may be generated by performing an invertible algebraic function such as XOR on a first block output from the third S-box 244 and a third round key 2 (RK2) 228. Ciphertext block C9 may be generated by performing an invertible algebraic function such as XOR on a second block output from the third S-box 244 and RK2 228. Ciphertext block C10 may be generated by performing an invertible algebraic function such as XOR on a third block output from the third S-box 244 and RK2 228. Ciphertext block C11 may be generated by performing an invertible algebraic function such as XOR on a fourth block output from the third S-box 244 and RK2 228.

In a similar manner, the fourth ciphertext block 270 may be generated as follows. Ciphertext block C12 may be generated by performing an invertible algebraic function such as XOR on a first block output from the fourth S-box 246 and a fourth round key 3 (RK3) 230. Ciphertext block C13 may be generated by performing an invertible algebraic function such as XOR on a second block output from the fourth S-box 246 and RK3 230. Ciphertext block C14 may be generated by performing an invertible algebraic function such as XOR on a third block output from the fourth S-box 246 and RK3 230. Ciphertext block C15 may be generated by performing an invertible algebraic function such as XOR on a fourth block output from the fourth S-box 246 and RK3 230.

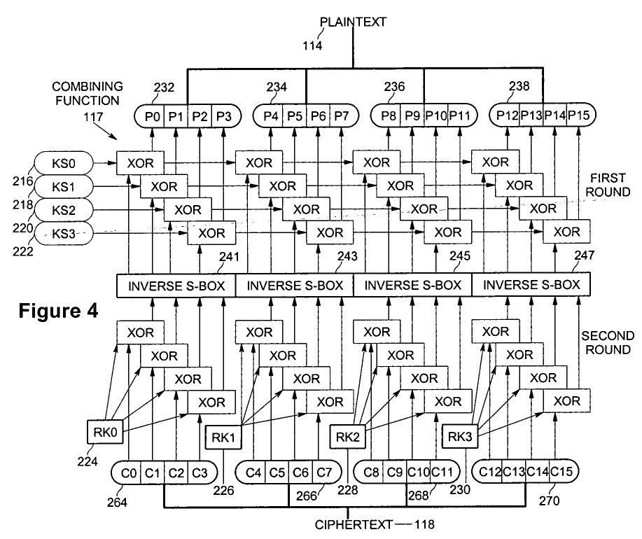

Although encryption of data is depicted in FIG. 3, one skilled in the art will be aware that decryption of data may be handled in a similar manner but with inverse operation processing. FIG. 4 is a block diagram illustrating combining function processing for decryption according to an embodiment of the present invention. As shown in FIG. 4, to decrypt ciphertext back into plaintext using a combining function 117, the data flows from the bottom to the top of the diagram for decryption (as opposed to a data flow from the top to the bottom for encryption as shown in FIG. 3). The S-boxes are replaced with the inverse operations to form inverse S-boxes 241, 243, 245, and 247, and the inverse functions of all other invertible algebraic functions may be used, as is well known in the art.

In other embodiments, various features of the cryptographic system shown in FIGS. 3 and 4 may be modified. For example, in one embodiment, the S-boxes may be removed. This may speed up system processing at a cost of reduced security. In an embodiment, invertible algebraic functions other than XOR may be used for the first and second rounds, such as addition or subtraction, for example. If addition or subtraction is used for encryption, the inverse operation must be used for decryption. In another embodiment, the algebraic functions used for the first and second rounds may be different. For example, XOR may used in the first round and two's complement addition may be used in the second round (or vice versa). In yet another embodiment, different invertible algebraic functions may be used for processing blocks in the same round. In another embodiment, the size of the blocks may be changed.

The combining function of the embodiments of the present invention allow for a small constant factor for performance improvement (e.g., up to 4 or 8 times better, depending on the particulars of the substitution operation) over that of a traditional stream cipher due to the relatively fast computation of the combining function compared to the underlying stream cipher.

When implemented in software, this may allow more processor performance to be used for processing of video data, for example, rather than content protection operations of the uncompressed video data, even if the very fastest conventional stream cipher were used. When implemented in hardware, a smaller number of gates would be required to attain the same performance.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A cryptographic system comprising:
a key stream generator to generate a key stream based at least in part on a key and an initialization vector;
a round key generator to generate a plurality of round keys based at least in part on the key stream; and
a combining function to generate a set of blocks of ciphertext data based at least in part on an equal size set of blocks of plaintext data, the key stream, and the round keys, the combining function including a first round of algebraic functions to operate on blocks of the plaintext data using a plurality of blocks of the key stream to produce a first intermediate result, a plurality of non-linear transformation functions to operate on the first intermediate result to produce a second intermediate result, and a second round of algebraic functions to operate on the second intermediate result using the round keys to produce the ciphertext data.

2. The cryptographic system of claim 1, wherein each block of plaintext data within the set is processed by the combining function using a unique combination of a selected key stream block and a selected round key.

3. The cryptographic system of claim 1, wherein each non-linear transformation function comprises a substitution box (S-box).

4. The cryptographic system of claim 1, wherein the size of the key stream is less than the size of the plaintext data.

5. The cryptographic system of claim 1, wherein the number of blocks of the key stream is equal to the number of round keys.

6. The cryptographic system of claim 1, wherein the first round of algebraic functions comprises a plurality of exclusive-or (XOR) functions.

7. The cryptographic system of claim 1, wherein each algebraic function of the first round accepts as input a block of the plaintext data and a block of the key stream to generate a block of the first intermediate result.

8. The cryptographic system of claim 1, wherein the second round of algebraic functions comprises a plurality of exclusive-or (XOR) functions.

9. The cryptographic system of claim 1, wherein each algebraic function of the second round accepts as input a block of the second intermediate result and one of the round keys to generate a block of the ciphertext data.

10. The cryptographic system of claim 1, wherein each block of plaintext data within the set of blocks of plaintext data is processed by the combining function substantially in parallel with all other blocks of the set to produce the ciphertext data.

11. A combining function comprising:
a first round of algebraic functions to operate on a set of blocks of plaintext data using a plurality of blocks of a key stream to produce a first intermediate result;
a plurality of non-linear transformation functions to operate on the first intermediate result to produce a second intermediate result; and
a second round of algebraic functions to operate on the second intermediate result using a plurality of round keys to produce a set of blocks of ciphertext data.

12. The combining function of claim 11, wherein each block of plaintext data within the set is processed by the combining function using a unique combination of a selected key stream block and a selected round key.

13. The combining function of claim 11, wherein each non-linear transformation function comprises a substitution box (S-box).

14. The combining function of claim 11, wherein the size of the key stream is less than the size of the plaintext data.

15. The combining function of claim 11, wherein the first round of algebraic functions comprises a plurality of exclusive-or (XOR) functions.

16. The combining function of claim 11, wherein each algebraic function of the first round accepts as input a block of the plaintext data and a block of the key stream to generate a block of the first intermediate result.

17. The combining function of claim 11, wherein the second round of algebraic functions comprises a plurality of exclusive-or (XOR) functions.

18. The combining function of claim 11, wherein each algebraic function of the second round accepts as input a block of the second intermediate result and one of the round keys to generate a block of the ciphertext data.

19. The combining function of claim 11, wherein each block of plaintext data within the set of blocks of plaintext data is processed by the combining function substantially in parallel with all other blocks of the set to produce the ciphertext data.

20. A method comprising:
generating a plurality of blocks of a key stream based at least in part on an initialization vector and a key;
generating a plurality of round keys, each round key based at least in part on a key stream block;
generating a set of blocks of ciphertext data from a set of blocks of plaintext data by:
performing a first algebraic function on each block of the plaintext data and a selected key stream block to produce a first intermediate result;
performing a non-linear transformation on the first intermediate result to produce a second intermediate result; and
performing a second algebraic function on each block of the second intermediate result and a selected round key to produce each block of the ciphertext data.

21. The method of claim 20, wherein each block of plaintext data within the set is processed using a unique combination of a selected key stream block and a selected round key.

22. The method of claim 20, wherein the size of the key stream is less than the size of the plaintext data.

23. The method of claim 22, wherein the number of blocks of the key stream is equal to the number of round keys.

24. The method of claim 20, wherein performing the first round of algebraic functions comprises performing a plurality of exclusive-or (XOR) functions.

25. The method of claim 20, wherein performing the second round of algebraic functions comprises performing a plurality of exclusive-or (XOR) functions.

26. The method of claim 20, wherein each block of plaintext data within the set of blocks of plaintext data is processed substantially in parallel with all other blocks of the set to produce the ciphertext data.

27. A method of generating a set of blocks of ciphertext data from a set of blocks of plaintext data comprising:
performing a first algebraic function on each block of the plaintext data and a selected block of a key stream to produce a first intermediate result;
performing a non-linear transformation on the first intermediate result to produce a second intermediate result; and
performing a second algebraic function on each block of the second intermediate result and a selected round key to produce each block of the ciphertext data, the selected round key being generated at least in part from the key stream.

28. The method of claim 27, wherein each block of plaintext data within the set is processed using a unique combination of a selected key stream block and a selected round key.

29. The method of claim 27, wherein the size of the key stream is less than the size of the plaintext data.

30. The method of claim 27, wherein each block of plaintext data within the set of blocks of plaintext data is processed substantially in parallel with all other blocks of the set to produce the ciphertext data.

31. A method comprising:
generating a plurality of round keys from blocks of a key stream; and
encrypting a set of blocks of plaintext data into a set of blocks of ciphertext data, wherein each block of plaintext data within the set is processed using a unique combination of a selected key stream block and a selected round key, and the size of the key stream is less than the size of the plaintext data.

32. The method of claim 31, wherein each block of plaintext data within the set of blocks of plaintext data is processed substantially in parallel with all other blocks of the set to produce the ciphertext data.

33. A cryptographic system comprising:
a key stream generator to generate a key stream based at least in part on a key and an initialization vector;
a round key generator to generate a plurality of round keys based at least in part on the key stream; and
a combining function to generate a set of blocks of plaintext data based at least in part on an equal size set of blocks of ciphertext data, the key stream, and the round keys, the combining function including a first round of algebraic functions to operate on blocks of the ciphertext data using the round keys to produce a first intermediate result, a plurality of non-linear inverse transformation functions to operate on the first intermediate result to produce a second intermediate result, and a second round of algebraic functions to operate on the second intermediate result using a plurality of blocks of the key stream to produce the plaintext data.

34. The cryptographic system of claim 33, wherein each block of ciphertext data within the set is processed by the combining function using a unique combination of a selected key stream block and a selected round key.

35. The cryptographic system of claim 33, wherein the size of the key stream is less than the size of the ciphertext data.

36. The cryptographic system of claim 33, wherein the number of blocks of the key stream is equal to the number of round keys.

37. The cryptographic system of claim 33, wherein at least one of the first round of algebraic functions and the second round of algebraic functions comprises a plurality of exclusive-or (XOR) functions.

38. The cryptographic system of claim 33, wherein each algebraic function of the first round accepts as input a block of the ciphertext data and a selected round key to generate a block of the first intermediate result.

39. The cryptographic system of claim 33, wherein each algebraic function of the second round accepts as input a block of the second intermediate result and a selected block of the key stream to generate a block of the plaintext data.

40. The cryptographic system of claim 33, wherein each block of ciphertext data within the set of blocks of ciphertext data is processed by the combining function substantially in parallel with all other blocks of the set to produce the plaintext data.

41. A combining function comprising:
a first round of algebraic functions to operate on a set of blocks of ciphertext data using a plurality of round keys to produce a first intermediate result;
a plurality of inverse non-linear transformation functions to operate on the first intermediate result to produce a second intermediate result; and
a second round of algebraic functions to operate on the second intermediate result using a plurality of blocks of a key stream to produce a set of blocks of plaintext data.

42. The combining function of claim 41, wherein each block of ciphertext data within the set is processed by the combining function using a unique combination of a selected key stream block and a selected round key.

43. The combining function of claim 41, wherein the size of the key stream is less than the size of the ciphertext data.

44. The combining function of claim 41, wherein at least one of the first round of algebraic functions and the second round of algebraic functions comprises a plurality of exclusive-or (XOR) functions.

45. The combining function of claim 41, wherein each algebraic function of the first round accepts as input a block of the ciphertext data and a round key to generate a block of the first intermediate result.

46. The combining function of claim 41, wherein each algebraic function of the second round accepts as input a block of the second intermediate result and a selected block of the key stream to generate a block of the plaintext data.

47. The combining function of claim 41, wherein each block of ciphertext data within the set of blocks of ciphertext data is processed by the combining function substantially in parallel with all other blocks of the set to produce the plaintext data.

48. A method comprising:
generating a plurality of blocks of a key stream based at least in part on an initialization vector and a key;
generating a plurality of round keys, each round key based at least in part on a key stream block;
generating a set of blocks of plaintext data from a set of blocks of ciphertext data by:
performing a first algebraic function on each block of the ciphertext data and a selected round key to produce a first intermediate result;
performing an inverse non-linear transformation on the first intermediate result to produce a second intermediate result; and
performing a second algebraic function on each block of the second intermediate result and a selected key stream block to produce each block of the plaintext data.

49. The method of claim 48, wherein each block of ciphertext data within the set is processed using a unique combination of a selected key stream block and a selected round key.

50. The method of claim 48, wherein the size of the key stream is less than the size of the ciphertext data.

51. The method of claim 48, wherein the number of blocks of the key stream is equal to the number of round keys.

52. The method of claim 48, wherein performing at least one of the first round of algebraic functions and the second round of algebraic functions comprises performing a plurality of exclusive-or (XOR) functions.

53. The method of claim 48, wherein each block of ciphertext data within the set of blocks of ciphertext data is processed substantially in parallel with all other blocks of the set to produce the plaintext data.

54. An article comprising: a storage medium having a plurality of machine readable instructions, wherein when the instructions are executed by a processor, the instructions
generate a plurality of blocks of a key stream based at least in part on an initialization vector and a key;
generate a plurality of round keys, each round key based at least in part on a key stream block;
generate a set of blocks of plaintext data from a set of blocks of ciphertext data by:
performing a first algebraic function on each block of the ciphertext data and a selected round key to produce a first intermediate result;
performing an inverse non-linear transformation on the first intermediate result to produce a second intermediate result; and
performing a second algebraic function on each block of the second intermediate result and a selected key stream block to produce each block of the plaintext data.

55. The article of claim 54, wherein each block of ciphertext data within the set is processed using a unique combination of a selected key stream block and a selected round key.

56. The article of claim 54, wherein the size of the key stream is less than the size of the ciphertext data.

57. The article of claim 54, wherein the number of blocks of the key stream is equal to the number of round keys.

58. The article of claim 54, wherein each block of ciphertext data within the set of blocks of ciphertext data is processed substantially in parallel with all other blocks of the set to produce the plaintext data.

59. A method of generating a set of blocks of plaintext data from a set of blocks of ciphertext data comprising:
performing a first algebraic function on each block of the ciphertext data and a selected round key to produce a first intermediate result;
performing an inverse non-linear transformation on the first intermediate result to produce a second intermediate result; and
performing a second algebraic function on each block of the second intermediate result and a selected block of a key stream to produce each block of the plaintext data, the selected round key being generated at least in part from the key stream.

60. The method of claim 59, wherein each block of ciphertext data within the set is processed using a unique combination of a selected key stream block and a selected round key.

61. The method of claim 59, wherein the size of the key stream is less than the size of the ciphertext data.

62. The method of claim 59, wherein each block of ciphertext data within the set of blocks of ciphertext data is processed substantially in parallel with all other blocks of the set to produce the plaintext data.

63. An article comprising: a storage medium having a plurality of machine readable instructions, wherein when the instructions are executed by a processor, the instructions generate a set of blocks of plaintext data from a set of blocks of ciphertext data by
performing a first algebraic function on each block of the ciphertext data and a selected round key to produce a first intermediate result;
performing an inverse non-linear transformation on the first intermediate result to produce a second intermediate result; and
performing a second algebraic function on each block of the second intermediate result and a selected block of a key stream to produce each block of the plaintext data, the selected round key being generated at least in part from the key stream.

64. The article of claim 63, wherein each block of ciphertext data within the set is processed using a unique combination of a selected key stream block and a selected round key.

65. The article of claim 63, wherein the size of the key stream is less than the size of the ciphertext data.

66. The article of claim 63, wherein each block of ciphertext data within the set of blocks of ciphertext data is processed substantially in parallel with all other blocks of the set to produce the plaintext data.

67. A method comprising:
generating a plurality of round keys from blocks of a key stream; and
decrypting a set of blocks of ciphertext data into a set of blocks of plaintext data, wherein each block of ciphertext data within the set is processed using a unique combination of a selected key stream block and a selected round key, and the size of the key stream is less than the size of the ciphertext data.

68. The method of claim 66, wherein each block of ciphertext data within the set of blocks of ciphertext data is processed substantially in parallel with all other blocks of the set to produce the plaintext data.

69. An article comprising: a storage medium having a plurality of machine readable instructions, wherein when the instructions are executed by a processor, the instructions generate a plurality of round keys from blocks of a key stream; and decrypt a set of blocks of ciphertext data into a set of blocks of plaintext data, wherein each block of ciphertext data within the set is processed using a unique combination of a selected key stream block and a selected round key, and the size of the key stream is less than the size of the ciphertext data.

70. The article of claim 69, wherein each block of ciphertext data within the set of blocks of ciphertext data is processed substantially in parallel with all other blocks of the set to produce the plaintext data.
